(19) United States
(12) Patent Application Publication
(10) Pub. No.: US 2003/0204383 A1
(43) Pub. Date: Oct. 30, 2003

(54) Visual manipulation

(76) Inventor: John Andrew Squire, Durango, CO (US)

Correspondence Address: JOHN A. SQUIRE, 455 EAST 8TH AVE., DURANGO, CO, 81301, US

(21) Appl. No.: 10/132,455

(22) Filed: Apr. 25, 2002

(51) Int. Cl. G06F 17/50

(52) U.S. Cl. 703/1

(57) ABSTRACT

This invention is a Visual Design Process, comprising of a series of analysis resulting in the creation of a unique nonuniform variegated surface coating which, wherein applied to the surface of Industrial Architectural components mimics and resembles the form, line, color, texture, spatial relationships and character of the environment or any combination thereof, in which it is located, visually manipulating, distorting and disrupting the visually perceivable shape and character of Industrial Architecture, structures, elements and other 3-dimensional components associated with Oil and Gas Industry and Industry as a whole.

### CROSS-REFERENCE-TO RELATED APPLICATIONS

CCL/427/262

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISK APPENDIX

“Not Applicable”

### BACKGROUND OF THE INVENTION

A recent approval to drill more than 650 additional Oil and Gas wells in rural SW Colorado has sparked numerous public hearings, town meetings, controversial debates and planning issues amongst the Public Sector, Industry, Local, State, Tribal, and Federal Agencies. Specific problems voiced during these sessions addressed the inadequate treatment of Visual Impact Mitigation, Aesthetics, Visual Quality, Human Dimension and diminishing Open Space.

I have invented a solution, which addresses and virtually solves all of these issues through a design process and application thereof.

### BRIEF SUMMARY OF THE INVENTION

Although there are strict rules and regulations associated with the Visual Impact Mitigation of Oil and Gas activities, they are inadequate to satisfy citizen issues and complaints which lead me to devise a cost effective solution to solve virtually all of the issues voiced at public hearings and meetings.

My invention is a visual design process and application thereof, comprising of a visual site analysis resulting in the ability to devise and produce a nonuniform variegated coating and its applied use on the surface of Industrial architecture, structures, elements and other associated 3 dimensional components blending them into the environment and rendering them less detectable and less identifiable in the environment.

This process was devised to specifically address issues and problems voiced at recent Oil and Gas Public hearings and can be used in other Industrial applications as well. The end result is a unique nonuniform variegated surface coating which resembles and mimics the form, line, color, texture, spatial relationships and character of the environment in which it is located, Site Specifically, Regionally or Globally.

### BRIEF DESCRIPTION OF THE SEVERAL VIEWS OF THE DRAWING

“Not Applicable”

### DETAILED DESCRIPTION OF THE INVENTION

This invention is a visual design process and its application thereof, comprising of a series of analysis used to gather information. Information is then translated and applied to devise, formulate and otherwise produce a unique image, with a variegated surface which varies in character and or color from one area to another where no repetitive pattern is discernible, and its application to Industrial Architectural structures, elements and other 3 dimensional components, mimicking the line, form, color, texture, spatial relationships and character of the environment in which the object is located.

This invention visually manipulates, distorts and disrupts the visually perceivable form, shape, and character of Industrial Architectural components in an environment, rendering them less identifiable and detectable creating a more harmonious visual relationship between Industrial Architectural components and the environment.

This invention solves virtually all issues voiced at public meetings addressing visual impact mitigation; aesthetics, visual quality, human dimension, and diminishing open space.

This invention exceeds the intended effects of current rules and regulations pertaining to visual impact mitigation. This visual design process is intended to be used and effective when used site specifically, regionally and globally or any combination thereof.

The process begins with a Visual site analysis comprising of:

1. Environmental Character Analysis: An inventory of attributes, qualities and traits of the environment that give it an image and make it identifiable or unique in terms of:

Line—inventory of ridges, skylines, structures, changes in vegetation.

Form—structure, mass or shape of an object defined by edges or outlines of landforms, rock forms vegetation patterns, water forms, buildings or enclosed spaces created by these attributes.

Color—The property of light reflecting of a particular wavelength that enables the eye to differentiate otherwise indistinguishable objects.

Texture—Visual interplay of light and shadow created by variations in the surface of an object, repetitive pattern of form or a repetitive pattern of form. Visual texture can range from smooth to coarse.

2. View Area Analysis—An inventory of the site location and where it can be observed from, based upon:

Landform Screening

Circulation Patterns

Residences

Vistas

The information gathered is then studied and applied to devise, formulate and produce a unique image, mimicking the line, form, color, texture, scale and character of the environment and background and any combination thereof.

The image produced is then transposed and applied to the Industrial Architectural, structures, elements and other 3 dimensional Industrial components in the environment. This is done using any known or available graphic, mechanical or technical skills i.e., free hand, in writing, visually, 2 or 3 dimensionally, a drawing, painting, sketch, photographically, digitally, with the use of computers, verbally or by any other method used to apply, communicate or depict the image produced from the Visual Site Analysis.

This invention is a Visual Manipulation design process, resulting in the creation of a unique nonuniform variegated surface coating wherein applied to the surface of Industrial Architectural components mimics and resembles the form, line, color, texture, spatial relationships and character of the environment or any combination thereof, in which the Industrial 3 dimensional components are located, visually manipulating, distorting and disrupting the visually perceivable shape and character of Industrial Architecture, structures, elements and other 3-dimensional components associated with Oil and Gas Industry and Industry as a whole.

This invention is intended rendering Industrial activity less detectable and identifiable, creating a more harmonious visual relationship between the Oil and Gas Industry and the environment while maintaining a sense of open space site specifically, regionally, and globally, reducing the visual presence of Industry on the planet Earth.

What I claim as my invention is:

1. A Visual Design Process, resulting in the creation of a unique nonuniform variegated surface coating wherein applied to the surface of Industrial Architectural components mimics and resembles the form, line, color, texture, spatial relationships and character of the environment or any combination thereof, in which the 3 dimensional components are located, visually manipulating, distorting, disrupting and disguising the visually perceivable shape and character of Industrial Architecture, structures, elements and other 3-dimensional components associated with Oil and Gas Industry and industry as a whole.

2. Claim 1 wherein the Visual Design Process is comprising of an Environmental Character Analysis, an inventory and analysis of attributes, qualities and traits of the environment that give it an image and make it identifiable or unique in terms of:
a) line analysis and inventory of ridges, skylines, structures, changes in vegetation;
(b) form analysis and inventory of structure, mass or shape of an object defined by edges or outlines of landforms, rock forms vegetation patterns, water forms, buildings or enclosed spaces created by these attributes;
(c) color analysis and inventory of the property of light reflecting of a particular wavelength that enables the eye to differentiate otherwise indistinguishable objects;
(d) textural analysis and inventory of the Visual interplay of light and shadow created by variations in the surface of an object, or a repetitive pattern of form, visual texture can range from smooth to coarse.

3. Claim 1 wherein the a Visual Design Process comprising of an analysis and inventory of the sit location and where it can be observed from based upon landform screening, circulation patterns, residences and vistas.

4. Claim 1 wherein the unique nonuniform variegated surface produced varies in character and or color from one area to another where no repetitive pattern is discernible is applied on a site-specific basis.

5. Claim 1 wherein the nonuniform variegated surface produced from this visual design process is applied to Industrial Architecture, structures, elements and other 3 dimensional components associated with the Oil and Gas Industry, rendering these components less detectable and identifiable in the environment lessening visual presence of industry on the landscape.

6. Claim 1 wherein this invention renders Oil and Gas Industry activity less detectable and identifiable, creating a more harmonious visual relationship between Industry and the environment while maintaining a “sense” of open space site specifically, regionally, and globally, reducing the visual presence of Industry on the planet Earth.
